(19) United States
(12) Patent Application Publication
(10) Pub. No.: US 2023/0166465 A1
(43) Pub. Date: Jun. 1, 2023

(54) PROCESS FOR THE PRODUCTION OF MANUFACTURED ARTICLES IN COMPOSITE MATERIAL

(71) Applicant: MOTORDESIGN MODENA S.r.l., Modena (IT)

(72) Inventor: William GUALTIERI, Modena (IT)

(73) Assignee: MOTORDESIGN MODENA S.r.l., Modena (IT)

(21) Appl. No.: 17/921,692

(22) PCT Filed: Apr. 27, 2021
(86) PCT No.: PCT/IB2021/053461

§ 371 Date: Oct. 27, 2022

(30) Foreign Application Priority Data
Apr. 27, 2020 (IT) 102020000009118

(51) Int. Cl. B29C 70/78; B29C 70/46; B60R 19/03; B60R 19/18; B32B 5/26; B32B 27/38; A41D 13/11

(52) U.S. Cl. CPC B29C 70/78; B29C 70/46; B60R 19/03; B60R 19/18; B32B 5/26; B32B 27/38; A41D 13/1138; B29K 2307/04

(57) ABSTRACT

A process for the production of manufactured articles in composite material comprises at least one supply phase of a plurality of layers and at least one coupling phase of the layers. The coupling phase comprises at least one step of arrangement of the layers overlapped onto each other to create at least one stratified body. The coupling phase comprises at least one step of positioning the stratified body inside a mould. The coupling phase comprises at least one firing step of the layers positioned inside the mould. The supply phase comprises at least one supply step of at least one basic layer and at least one supply step of at least one reinforcement layer.

### TECHNICAL FIELD

The present invention relates to a process for the production of manufactured articles in composite material.

### BACKGROUND ART

Several processes are known for the production of manufactured articles in composite material used in different fields of technology to make manufactured articles having special mechanical and structural properties depending on their use.

It is well known, in fact, that the need is particularly felt, in many sectors of industrial and commercial activities, to renew the produced manufactured articles and to search for new ones in order to distinguish these from those of competitors.

In particular, in order to obtain more and more performing mechanical properties, the processes of known type envisage carrying out coupling operations of materials of different nature having different mechanical and structural characteristics in order to obtain composite manufactured articles of various types.

In this way, such processes allow for the production of a wide variety of composite manufactured articles, such as e.g. materials for the manufacture of nautical accessories or, as an alternative, for the manufacture of personal protective equipment.

These types of processes are however open to improvement.

In fact, the manufactured articles made through these processes are particularly fragile and subject to wear and tear.

Moreover, depending on the type of article to be manufactured and its mechanical and structural characteristics, the processes of known type require the use of a wide variety of materials and the execution of as many different processing operations on these materials.

These drawbacks make the manufactured articles obtained from these processes unattractive to the market and significantly increase the cost of production of the same.

### DESCRIPTION OF THE INVENTION

The main aim of the present invention is to devise a process for the production of manufactured articles in composite material which enables the manufacture of particularly strong and durable articles.

One object of the present invention is to devise a process for the production of manufactured articles in composite material which allows a particularly limited number of materials to be used to make a wide variety of manufactured articles having different mechanical and structural characteristics.

A further object of the present invention is to devise a process for the production of manufactured articles in composite material which allows a limited number of operations, as compared to the processes of known type, to be carried out to make a wide variety of manufactured articles having different mechanical and structural characteristics.

Another object of the present invention is to devise a process for the production of manufactured articles in composite material which allows overcoming the aforementioned drawbacks of the prior art within a simple, rational, easy, effective to use and low cost solution.

The aforementioned objects are achieved by the present process for the production of manufactured articles in composite material having the characteristics of claim 1.

The aforementioned objects are achieved by the present manufactured bumper article for motor vehicles having the characteristics of claim 10.

### BRIEF DESCRIPTION OF THE DRAWINGS

Other characteristics and advantages of the present invention will become more evident from the description of a preferred, but not exclusive, embodiment of a process for the production of manufactured articles in composite material, illustrated by way of an indicative, yet non-limiting example, in the accompanying tables of drawings wherein:

FIG. 1 is a schematic axonometric view of a manufactured article made through the process according to the invention;

FIG. 2 is a schematic axonometric view of an additional manufactured article made through the process according to the invention;

FIGS. 3 to 5 are schematic views showing some of the steps of the process according to the invention;

FIG. 6 is a schematic axonometric view of a manufactured article made by means of an alternative embodiment of the process according to the invention;

FIG. 7 is a schematic view showing one step of the process according to the invention for the production of the manufactured article shown in FIG. 6.

### EMBODIMENTS OF THE INVENTION

With particular reference to such figures, reference numeral 1 globally indicates a manufactured article made by means of the process for the production of manufactured articles in composite material.

It is specified that within the scope of the present disclosure, the term “manufactured article” generally means any product directly obtained by the performance of the process according to the present invention, such as, e.g., manufactured articles for individual protection or, alternatively, accessories of the nautical type.

Alternatively, the term “manufactured article” relates to accessories for the automotive or nautical sector of the type e.g. of instrumentation consoles, hard tops and interior and exterior furniture items such as ladders, tables, desks, and the like.

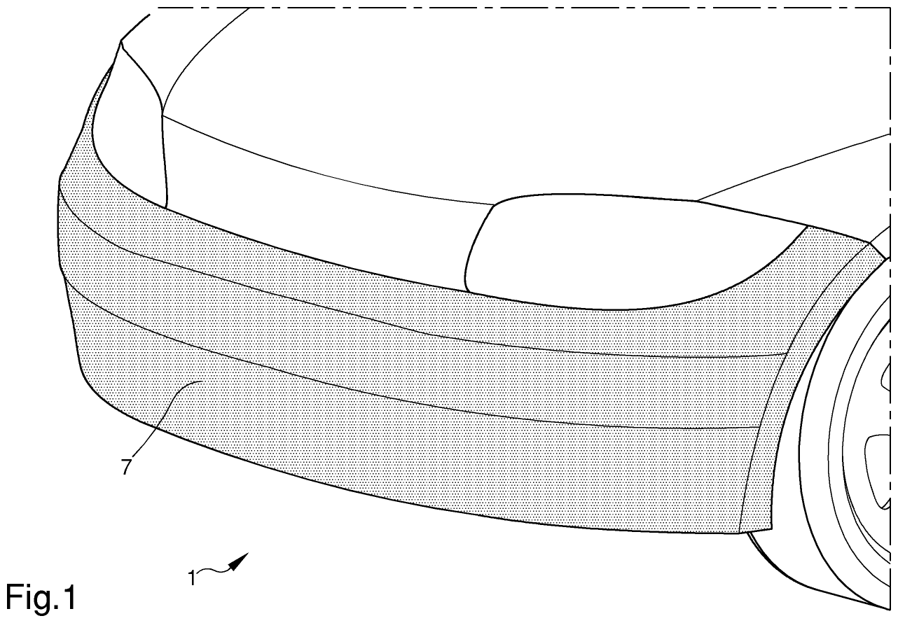

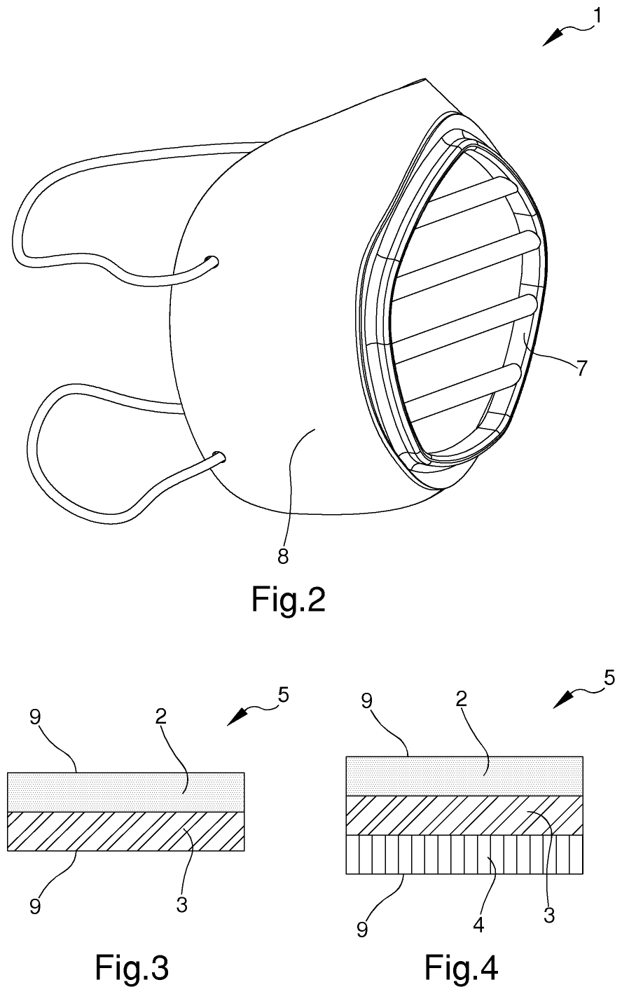

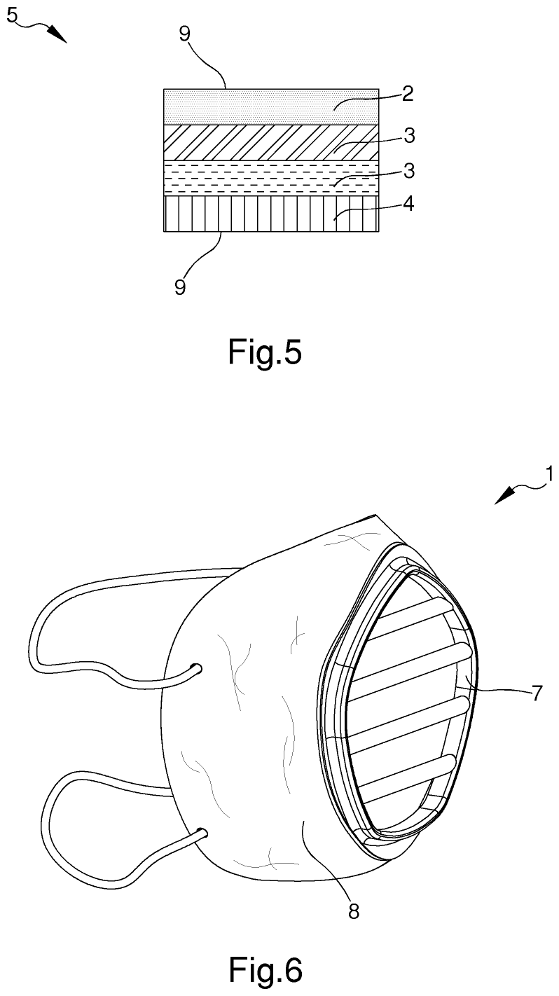

In this regard, it is specified that a preferred embodiment of the manufactured article obtained by means of the process according to the present invention consisting of a manufactured bumper article for motor vehicles is shown in FIG. 1.

Different embodiments of the manufactured article obtained by the process according to the present invention cannot however be ruled out, e.g. of the type of a manufactured article for individual face protection.

The process for the production of manufactured articles 1 in composite materials comprises:
at least one supply phase of a plurality of layers 2, 3, 4;
at least one coupling phase of the layers 2, 3, 4 to make the manufactured article 1.

Advantageously, the supply phase of a plurality of layers 2, 3, 4 comprises a supply step of at least one basic layer 2 made of elastomeric material and at least one supply step of at least one reinforcement layer 3 made of a material selected from the list comprising glass fiber, dry carbon fiber and carbon fiber impregnated with thermosetting resin.

In the context of the present treatise, the expression “elastomeric material” means natural or synthetic rubber. In particular, reference is made to that class of macromolecules belonging to the polymer family, which shows high elasticity characteristics, i.e. materials that have a clear deformation when subjected to relatively small stresses, but which are able to rapidly recover their initial state (shape and size) as soon as the applied stress is removed.

Preferably, the elastomeric material is selected from the list comprising: polyacrylic rubber (ACM), ethylene acrylate rubber (AEM), copolymer of acrylic acid ester and acrylonitrile (ANM), ethylene propylene diene monomer rubber (EPDM), ethylene propylene monomer rubber (EPM), fluorinated rubber (FEPM, FKM), thermoplastic polyurethane rubber (TPU).

In addition, thermosetting resin is selected from the list comprising: epoxy resin, phenolic resin, polyurethane resin, melamine resin, vinyl ester resin.

Preferably, the resin is an epoxy resin.

Conveniently, the elastic properties of the basic layer 2 make it particularly suitable for contact with the skin of a user also for considerably long times.

In fact, the flexibility of the basic layer 2 allows for a better adherence to the user's skin and also avoids generating friction as a result of the basic layer rubbing against the skin itself.

This helps to avoid irritation on the user's skin.

The reinforcement layer 3, on the other hand, defines a layer adapted to give strength to the manufactured article 1.

More in detail, the reinforcement layer 3 acquires different mechanical characteristics depending on the type of material selected to make it.

In fact, the reinforcement layer 3 made of carbon fiber impregnated with thermosetting resin defines a stiff and strong reinforcement layer 3.

Furthermore, the supply step of the reinforcement layer 3 made of carbon fiber comprises an intermediate step of application of a predefined amount of thermosetting resin to the carbon fiber. Said predefined amount is measured by means of a density parameter of the resin per square centimeter of carbon fiber and is selected depending on the stiffness to be given to the reinforcement layer 3.

On the other hand, the reinforcement layer 3 made of dry carbon fiber defines a reinforcement layer 3 having lower stiffness than the reinforcement layer made of impregnated carbon fiber.

In other words, the reinforcement layer 3 made of dry carbon fiber defines an elastically deformable and strong reinforcement layer 3.

Specifically, the term “dry carbon fiber” is meant to indicate a material made of carbon fiber, free of liquid additives.

Advantageously, the dry carbon fiber features characteristics similar to those owned by leather and therefore can be treated as such for the production of manufactured articles of the type of highly resistant fabrics used e.g. in the fashion industry, technical sportswear, technical equipment and the like.

Advantageously, at least one of the layers 2, 3, 4 is made of elastically deformable and/or shape memory material.

Conveniently, the supply step of a plurality of layers 2, 3, 4 comprises a supply step of a plurality of reinforcement layers 3.

Preferably, the supply step of a plurality of reinforcement layers 3 comprises the supply step of a reinforcement layer 3 made of a material selected from the list comprising glass fiber, dry carbon fiber and impregnated carbon fiber, and the supply step of a reinforcement layer 3 made of a different material selected from the same list.

In this way, each reinforcement layer 3 used in the production of the manufactured article 1 gives the same different characteristics.

Advantageously, the supply step of a plurality of layers 2, 3, 4 comprises a supply step of a coating layer 4 made of a material selected from the list comprising rubber, fabric, leather, and wood.

In particular, the coating layer 4 defines a layer adapted to give special aesthetic characteristics to the manufactured article 1.

In fact, the coating layer 4 is intended, in use, to be visible.

Conveniently, the coupling phase of the layers 2, 3, 4 comprises at least one step of arrangement of the layers 2, 3, 4 overlapped onto each other to create a stratified body 5.

Therefore, the stratified body 5 made in this way comprises a pair of visible faces 9 arranged opposite each other.

This step of arrangement of the layers 2, 3, 4 gives special characteristics to the manufactured product 1 derived from the synergy of the different layers 2, 3, 4 overlapped onto each other.

For example, the basic layer 2 and the reinforcement layer 3 significantly increase the strength and durability of the manufactured product 1. Indeed, in the event of the reinforcement layer 3 being damaged, such as chipped, broken, or suffers similar damage, it remains integrally bonded to the adjacent basic layer 2 without compromising the soundness of the entire manufactured product 1.

In particular, the step of arrangement of the layers 2, 3, 4 comprises a step of overlapping the basic layer 2 onto the reinforcement layer 3.

This solution gives the stratified body 5 the combination of the characteristics of the basic layer 2 and of the reinforcement layer 3.

In particular, one visible face 9 is defined by the basic layer 2 and the other visible face 9 is defined by the reinforcement layer 3.

Advantageously, the step of arrangement of the layers 2, 3, 4 comprises at least one step of overlapping a reinforcement layer 3 onto another reinforcement layer 3.

This solution gives the stratified body 5 additional structural characteristics.

For example, overlapping a reinforcement layer 3 made of carbon fiber onto a reinforcement layer 3 made of glass fiber gives the manufactured article 1 strength and elasticity.

Conveniently, the step of arrangement of the layers 2, 3, 4 comprises at least one step of overlapping the covering layer 4 onto the reinforcement layer 3.

This solution gives the stratified body 5 the combination of the characteristics of the basic layer 2, the reinforcement layer 3 and the covering layer 4.

In addition, by means of carrying out the overlapping step of the covering layer 4 onto the reinforcement layer 3, a visible face 9 is defined by the basic layer 2 and the other visible face 9 is defined by the covering layer 4.

Further embodiments of the process cannot however be ruled out, wherein the same comprises a supply step of a plurality of basic layers 2 and at least one step of overlapping a basic layer 2 onto a reinforcement layer 3 to make at least one basic layer 2 positioned between two reinforcement layers 3.

Advantageously, the coupling phase of the layers 2, 3, 4 comprises at least one step of positioning the stratified body 5 inside at least one mould 6 defining at least partly the conformation of the manufactured article 1 to be produced.

Preferably, the positioning comprises an intermediate positioning step of one of either the basic layer 2, the reinforcement layer 3 or the covering layer 4 inside the mould 6.

Advantageously, the intermediate positioning step is carried out prior to the step of arrangement.

In this way, each overlapping step is carried out directly inside the mould 6.

In other words, in this way, the overlapping steps of the layers 2, 3, 4 making up the stratified body 5 allow the positioning thereof inside the mould 6.

Further embodiments of the process cannot however be ruled out wherein the step of positioning comprises a step of housing the stratified body 5 inside the mould 6 with the basic layer 2 arranged in contact with the mould 6.

Appropriately, in this embodiment of the process, the step of housing is carried out subsequently to the step of arrangement.

Advantageously, the coupling phase comprises at least one firing step of the layers 2, 3, 4 positioned inside the mould 6.

In particular, the firing step is carried out at a temperature ranging from 90 C.° to 160 C°.

In particular, in an embodiment of the process wherein the supply step comprises the supply of a covering layer 4 made of wood, the firing step is carried out at a temperature substantially of 140 C°.

Preferably, the firing step is carried out by means of an autoclave.

In addition, the firing step is carried out, preferably over a period of 1 to 24 hours.

Advantageously, the firing step is carried out under pressure. Said pressure is selected from a range of values comprised between 1 and 12 bar. Preferably, the pressure is selected between 3 and 10 bar or between 5 and 8 bar.

Conveniently, the firing step is carried out under vacuum.

In particular, the firing step gives the layers 2, 3, 4 scratch resistance and/or softness to the touch.

In particular, the firing step is adapted to fix the layers 2, 3, 4 to each other.

Conveniently, the coupling phase comprises at least one cooling step of the layers 2, 3, 4 carried out after the firing phase.

Preferably, the cooling step is carried out over a period of 1 to 4 hours.

In particular, the cooling step is adapted to fix the shape given to the layers 2, 3, 4 by the mould 6 to make the manufactured article 1.

The manufactured article 1 made by carrying out the process is described below, wherein the manufactured article 1 is of the type of a bumper for motor vehicles.

In particular, the manufactured bumper article 1 for motor vehicles comprises at least one supporting frame 7 provided with at least one protective portion 7 arranged, in use, to cover at least part of a vehicle, wherein the supporting frame 7 comprises at least one basic layer 2 and at least one reinforcement layer 3.

Advantageously, the basic layer 2 and the reinforcement layer 3 are made of elastically deformable materials.

According to a preferred, but not exclusive embodiment of the manufactured bumper article 1 for motor vehicles, the basic layer 2 and the reinforcement layer 3 are made of shape memory materials.

Advantageously, the manufactured bumper article 1 comprises one or more stratified bodies 5 wherein, in use, one of the stratified bodies 5 faces the vehicle and one of the stratified bodies 5 faces outside the vehicle and is made visible.

In particular, if the manufactured bumper article 1 comprises an individual stratified body 5, the latter is provided with a portion facing the vehicle and with another portion facing outside the vehicle and made visible.

Otherwise, if the manufactured bumper article comprises a plurality of stratified bodies 5, one of the stratified bodies 5 faces the vehicle and the other of the stratified bodies 5 faces outside the vehicle and is made visible.

Conveniently, at least one of the stratified bodies 5 is made of elastically deformable and/or shape memory material.

The manufactured article 1 made by carrying out the process is described below, wherein the manufactured article 1 is of the type of a manufactured article 1 for individual face protection.

The manufactured article 1 for individual face protection comprises at least one supporting frame 7, 8 provided with:
at least one protective portion 7 arranged, in use, to cover at least part of the face of a user;
at least one contact portion 8 associated with the protective portion 7 and arranged, in use, in contact with the skin of the user.

Advantageously, the supporting frame 7, 8 comprises one basic layer 2 and at least one reinforcement layer 3.

Further embodiments of the manufactured article 1 cannot however be ruled out wherein the same comprises a plurality of reinforcement layers 3.

In addition, further embodiments of the manufactured article 1 cannot be ruled out wherein the same comprises a covering layer 4.

In particular, the protective portion 7 and the contact portion 8 are made in a single body piece and comprise the stratified body 5.

Preferably, the stratified body 5 forms the protective portion 7 and the contact portion 8.

Advantageously, the manufactured article 1 made in this way is particularly resistant to temperatures of up to 100° C.

Thus, such manufactured articles 1 are adapted to undergo the high temperature processes generally employed for sterilization of medical health care equipment.

An alternative embodiment of the process is described below.

In particular, this alternative embodiment differs from the one described above by the fact that it comprises a plurality of supply phases of a plurality of layers 2, 3, 4.

In addition, according to this embodiment, the coupling phase comprises:
a plurality of steps of arrangement of the layers 2, 3, 4 overlapping onto each other to create a plurality of stratified bodies 5, wherein the reinforcement layer 3 of at least a stratified body 5 is made of a material selected from the list comprising glass fiber, dry carbon fiber and carbon fiber impregnated with thermosetting resin, and wherein the reinforcement layer 3 of at least another stratified body 5 is made of a different material selected from the same list;
a plurality of positioning steps;
at least one juxtaposing step of the stratified bodies 5 inside the mould 6.

In particular, the juxtaposing step is adapted to prepare the stratified bodies 5 inside the mould 6 for the firing step.

In fact, the firing step is adapted to mutually associate the stratified bodies 5 juxtaposed to each other inside the mould 6 to make an individual manufactured article 1.

Thus, the manufactured article 1 made by means of this process comprises portions provided with stratified bodies 5 having layers 2, 3, 4 different from each other.

This solution allows making manufactured articles 1 having portions with different structural characteristics, for example, depending on the function of these portions.

According to a preferred, but not exclusive, embodiment of the process, the same comprises at least a first and at least a second supply phase of a plurality of layers 2, 3, 4 and at least as many steps of arrangement of the layers 2, 3, 4 supplied to make a plurality of stratified bodies 5.

Preferably, each stratified body comprises a basic layer 2.

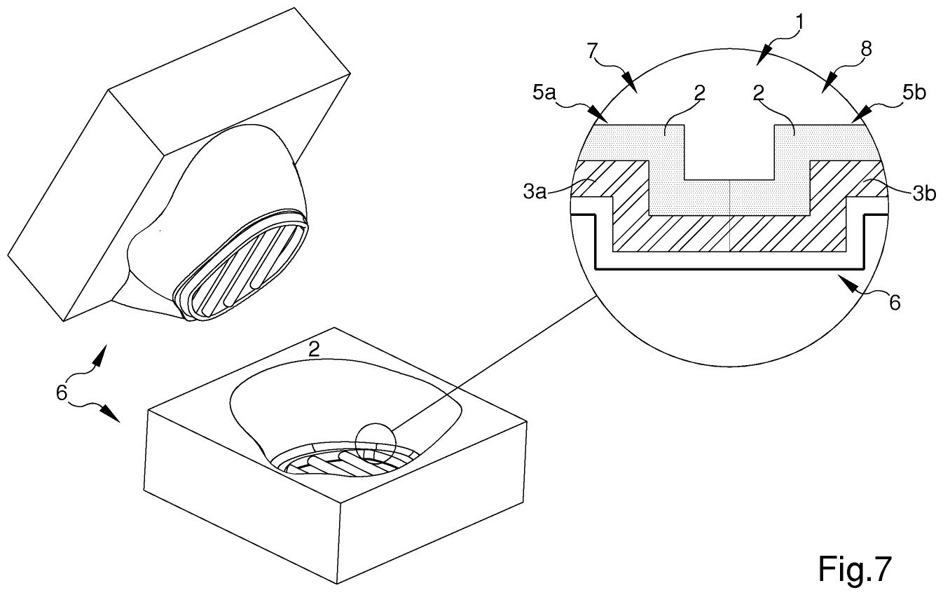

Specifically, two stratified bodies 5 are shown in FIG. 7, denoted by the numbers 5a and 5b, respectively, in order to make them distinguishable.

Similarly, the reinforcement layers 3 of the stratified body 5a and of the stratified body 5b have been denoted by the numbers 3a and 3b, respectively.

Advantageously, the stratified body 5a and the stratified body 5b respectively comprise at least one reinforcement layer 3a made of dry carbon fiber and at least one reinforcement layer 3b made of impregnated carbon fiber.

Furthermore, conveniently, the juxtaposing step comprises a step of flanking the reinforcement layer 3a with the reinforcement layer 3b to substantially define an individual continuous reinforcement layer 3 at the end of the coupling phase.

The manufactured article 1 made by means of this alternative embodiment of the process differs from the manufactured article 1 described above by the fact that the protective portion 7 comprises the stratified body 5a and the contact portion 8 comprises the stratified body 5b.

Preferably, the stratified body 5a forms the protective portion 7 and the stratified body 5b forms the contact portion 8.

It has in practice been ascertained that the described invention achieves the intended objects.

In particular, the fact is emphasized that the supply step of a basic layer made of rubber and of a reinforcement layer made of a material selected from glass fiber, dry carbon fiber and impregnated carbon fiber allows making manufactured articles particularly strong and durable.

In addition, the coupling phase allows making a wide variety of manufactured articles with different mechanical and structural characteristics through the use of a limited number of materials and of a reduced number of process steps.

1) A process for the production of manufactured articles in composite material, the process comprising:
at least one supply phase of a plurality of layers;
at least one coupling phase of said layers to make said manufactured article;
wherein said coupling phase comprises at least one step of arrangement of said layers overlapped onto each other to create at least one stratified body;
wherein said coupling phase comprises at least one step of positioning said stratified body inside a mould defining at least partly the conformation of said manufactured article to be produced;
wherein said coupling phase comprises at least one firing step of said layers positioned inside said mould, said firing step being carried out at a temperature ranging from 90 C.° to 160 C.°; and
wherein said supply phase comprises at least one supply step of at least one basic layer made of elastomeric material and at least one supply step of at least one reinforcement layer made of a material selected from the list comprising glass fiber, dry carbon fiber and carbon fiber impregnated with thermosetting resin.

2) The process according to claim 1, wherein said supply phase of a plurality of layers comprises a supply step of a plurality of reinforcement layers.

3) The process according to claim 1, wherein said supply phase of a plurality of layers comprises a supply step of a covering layer made of a material selected from the list comprising rubber, fabric, leather and wood.

4) The process according to claim 1, wherein said step of arrangement of said layers comprises a step of overlapping said basic layer onto said reinforcement layer.

5) The process according to claim 1, wherein said step of arrangement of said layers comprises at least one step of overlapping one of said reinforcement layers onto another of said reinforcement layers.

6) The process according to claim 1, wherein said step of arrangement of said layers comprises at least one step of overlapping said covering layer onto said reinforcement layer.

7) The process according to claim 1, further comprising: a plurality of said supply phases of a plurality of said layers and by the fact that said coupling phase comprises:
a plurality of said steps of arrangement of said layers overlapping onto each other to create a plurality of said stratified bodies, wherein the reinforcement layer of at least one stratified body k is made of a material selected from the list comprising glass fiber, dry carbon fiber and carbon fiber impregnated with thermosetting resin, and wherein the reinforcement layer of at least another stratified body is made of a different material selected from the same list;
a plurality of said positioning steps;
at least one juxtaposing step of said stratified bodies inside said mould.

8) The process according to claim 1, wherein said coupling phase comprises at least one cooling step of said layers carried out after said firing phase.

9) The process according to claim 1, wherein said firing step is carried out under pressure between a range of values from 1 to 12 bar.

10) A manufactured bumper article for motor vehicles, made by means of the process according to claim 1 and comprising at least one supporting frame provided with at least one protective portion arranged, in use, to cover at least part of a vehicle, wherein said supporting frame comprises said at least one basic layer and said at least one reinforcement layer.

11) The manufactured article according to claim 10, further comprising: one or more of said stratified bodies wherein, in use, one of said stratified bodies faces the vehicle and one of said stratified bodies faces outside the vehicle and is made visible.

12) The manufactured article according to claim 10, wherein at least one of said stratified bodies is made of elastically deformable and/or shape memory material.

13) A method for the production of manufactured articles in composite material, the method comprising:
arranging a plurality of layers overlapped onto each other to create at least one stratified body;
positioning said stratified body inside a mould defining at least partly the conformation of said manufactured article to be produced;
firing of said layers positioned inside said mould, said firing being carried out at a temperature ranging from 90 C.° to 160 C.°; and
supplying at least one basic layer made of elastomeric material and supplying at least one reinforcement layer made of a material selected from the list comprising glass fiber, dry carbon fiber and carbon fiber impregnated with thermosetting resin.

14) A manufactured bumper article for motor vehicles, made by means of the method according to claim 13 and comprising at least one supporting frame provided with at least one protective portion arranged, in use, to cover at least part of a vehicle, wherein said supporting frame comprises said at least one basic layer and said at least one reinforcement layer.
